(19) United States
(12) Patent Application Publication
(10) Pub. No.: US 2015/0130688 A1
(43) Pub. Date: May 14, 2015

(54) Utilizing External Devices to Offload Text Entry on a Head Mountable Device

(71) Applicant: Google Inc., Mountain View, CA (US)

(72) Inventors: Chun Yat Frank Li, Mountain View, CA (US); Nirmal Patel, Sunnyvale, CA (US)

(73) Assignee: Google Inc., Mountain View, CA (US)

(21) Appl. No.: 14/078,255

(22) Filed: Nov. 12, 2013

(51) Int. Cl. G02B 27/01

(52) U.S. Cl. CPC G02B 27/017
USPC 345/8

(57) ABSTRACT

Methods and systems are described herein for providing text to a head-mountable display (HMD) from a remote device. The remote device can receive a notification of an event related to the HMD. The remote device can determine whether the event corresponds to a text input for the HMD. After determining that the event does corresponds to the text input, the remote device can: cause a display of a text-input interface on the HMD, receive text using a text-input component of the remote device, and send the text to the HMD.

### BACKGROUND

Unless otherwise indicated herein, the materials described in this section are not prior art to the claims in this application and are not admitted to be prior art by inclusion in this section.

Computing systems such as personal computers, laptop computers, tablet computers, cellular phones, and countless types of Internet-capable devices are prevalent in numerous aspects of modern life. Over time, the manner in which these devices are providing information to users is becoming more intelligent, more efficient, more intuitive, and/or less obtrusive.

The trend toward miniaturization of computing hardware, peripherals, as well as of sensors, detectors, and image and audio processors, among other technologies, has helped open up a field sometimes referred to as wearable computing that can utilize head-mountable displays (HMDs). In the area of image and visual processing and production, in particular, it has become possible to consider wearable displays that place a very small image display element close enough to a wearer's (or user's) eye(s) such that the displayed image fills or nearly fills the field of view, and appears as a normal sized image, such as might be displayed on a traditional image display device. The relevant technology can be referred to as “near-eye displays.”

Near-eye displays are fundamental components of wearable displays, also sometimes called head-mounted displays (HMDs). A head-mounted display places a graphic display or displays close to one or both eyes of a wearer. To generate the images on a display, a computer processing system can be used. Such displays can occupy part or all of a wearer's field of view. Further, head-mounted displays can be as small as a pair of glasses or as large as a helmet.

### SUMMARY

In one aspect, a method is provided. A remote device receives a notification of an event related to a head-mountable display (HMD). The remote device determines whether the event corresponds to a text input for the HMD. After the remote device determines that the event corresponds to the text input, the remote device: causes display of a text-input interface on the HMD, receives text using a text-input component of the remote device, and sends the text to the HMD.

In another aspect, a method is provided. A remote device receives an instruction that text be provided to a HMD. The remote device is configured to communicate with at least the HMD. In response to the instruction, a text-input component of the remote device is provided. The text-input component is configured for obtaining text for the HMD. After providing the text-input component, the remote device receives first text via the text-input component and sends the first text to the HMD.

In another aspect, a remote device is provided. The remote device includes a text-input component, a processor, and a non-transitory computer-readable medium that is configured to store program instructions that, when executed by the processor, cause the remote device to carry out functions. The functions include: receiving a notification of an event related to an HMD; determining whether the event corresponds to a text input for the HMD; and after determining that the event does corresponds to the text input: causing display of a text-input interface on the HMD, receiving text using the text-input component, and sending the text to the HMD.

In another aspect, a non-transitory computer-readable medium is provided. The non-transitory computer-readable medium is configured to store program instructions that, when executed by a processor of a remote device, cause the remote device to carry out functions. The functions include: receiving a notification of an event related to an HMD; determining whether the event corresponds to a text input for the HMD; and after determining that the event does corresponds to the text input: causing a display of a text-input interface on the HMD, receiving text using a text-input component of the remote device, and sending the text to the HMD.

In another aspect, a device is provided. The device includes: text-input means; means for receiving a notification of an event related to an HMD; means for determining whether the event corresponds to a text input for the HMD; and means for, after determining that the event does correspond to the text input: causing display of a text-input interface on the HMD, receiving text via the text-input means, and sending the text to the HMD.

In another aspect, a remote device is provided. The remote device includes a text-input component, a processor, and a non-transitory computer-readable medium that is configured to store program instructions that, when executed by the processor, cause the remote device to carry out functions. The functions include: receiving an instruction that text be provided to a HMD; in response to the instruction, providing the text-input component, where the text-input component is configured for obtaining text for the HMD; and after providing the text-input component, receiving text via the text-input component, and sending the text to the HMD.

In another aspect, a non-transitory computer-readable medium is provided. The non-transitory computer-readable medium is configured to store program instructions that, when executed by a processor of a remote device, cause the remote device to carry out functions. The functions include: receiving an instruction that text be provided to a HMD; responsive to the instruction, providing a text-input component, where the text-input component is configured for obtaining text for the HMD; and after providing the text-input component, receiving first text via the text-input component, and sending the first text to the HMD.

In another aspect, a device is provided. The device includes: text-input means; means for receiving an instruction that text be provided to a HMD; means for, responsive to the instruction, providing the text-input means, where the text-input means is configured for obtaining text for the HMD; means for, after providing the text-input means, receiving text via the text-input means and for sending the text to the HMD.

### BRIEF DESCRIPTION OF THE DRAWINGS

FIG. 1A illustrates an HMD according to an example embodiment.

FIG. 1B illustrates an alternate view of the HMD illustrated in FIG. 1A.

FIG. 1C illustrates another HMD according to an example embodiment.

FIG. 1D illustrates another HMD according to an example embodiment.

FIGS. 1E to 1G are simplified illustrations of the HMD shown in FIG. 1D, being worn by a wearer.

FIG. 2 illustrates an HMD configured for communication with a remote device, according to an example embodiment.

FIGS. 3A and 3B illustrate a scenario for communicating text from a remote device previously requested by a HMD, according to an example embodiment.

FIGS. 4A and 4B illustrate a scenario for communicating text from a remote device not previously requested by a HMD, according to an example embodiment.

FIG. 4C illustrates additional examples of an application dialog and display of received text, according to an example embodiment.

FIG. 4D illustrates another scenario for communicating text from a remote device not previously requested by an HMD, according to an example embodiment.

FIG. 4E illustrates another scenario for communicating text from a remote device not previously requested by an HMD, according to an example embodiment.

FIG. 5A is a flow chart of a method, according to an example embodiment.

FIG. 5B is a flow chart of another method, according to an example embodiment.

### DETAILED DESCRIPTION

### I. Overview

To aid the use of HMDs and, perhaps other computing devices, a user interface of a remote device that is not necessarily directly attached to a wearable computing system can be utilized. Specifically, systems and methods described herein allow a user interface of a remote device to be coupled to a computing system and enable a user to operate a remote user-interface to enter text for the wearable computing system in an efficient, convenient, or otherwise intuitive manner.

As a non-limiting, contextual example of a situation in which the systems disclosed herein may be implemented, consider a wearable computing system. While a wearable computing system may have a text entry capability, in some scenarios, a remote device configured to provide a remote user-interface for the HMD can support entry of text to be utilized by the wearable computing system. The remote device and HMD can be communicatively linked. The remote device can be a device configured to enter text, for instance, a smart phone, desktop, laptop, other wearable devices (e.g. ring or bracelet keyboard), additional keyboard-enabled devices, or other computing device(s). Text entered using the remote device can be sent from the remote device to the HMD. Then, the HMD can utilize the text as needed; e.g., as a password, a network address, captioning figures, sending text messages and other communications, and for many other purposes.

The HMD and the remote device can be connected, or otherwise communicatively coupled, using one or more wireless protocols, such as but not limited to Bluetooth, Wi-Fi, and other wireless protocols. In other embodiments, the HMD and the remote device can be connected, or otherwise communicatively coupled, using one or more wired connections, such as, but not limited to, a USB or Ethernet connection. In even other embodiments, both wired and wireless connections can be utilized between the HMD and the remote device.

In some cases, the HMD can request text from the remote device, and the remote device can subsequently provide the requested text to the remote device. In other cases, the remote device, once communicatively coupled to the HMD, can provide text without the HMD requesting the text.

The text can be screened to include and/or exclude types of text before being sent to the HMD. For example, if the text is intended to be used as a numeric personal identification number (PIN), then the text can be screened to be numeric-only, and any non-numeric text can be excluded from the text provided to the HMD. As another example, if a name is to be provided, the text can be screened to include alpha-numeric text with symbols but exclude symbols not typically found in a name; e.g., “!”, “#”, “<”, “>”, “*”, “+”, “{”, “[”, “]”, “}”, quotation marks, etc.

The requested text can be displayed on the remote device and/or HMD depending on the type of requested text. Using the PIN example above, the requested text may not be displayed at all or may be displayed using other characters, such as a string of “*”'s corresponding to the characters of the PIN. In other examples, such as the name example above, requested text can be displayed as entered; e.g., “Franklin D. Roosevelt”. In other examples, text can be displayed with related information, such as hints. For example, if the requested text is to be used for a network password, then a hint can be provided that includes the network name, network identification such as SSID, user name, and/or other related information to aid the entry of the requested text.

The use of a remote device can ease text entry for a HMD. The remote device can provide a reliable and fast text-input component, such as a keyboard, for text entry. In some cases, the remote device can have software, such as spell-checking software or other verification software, to verify correctness of text before providing the text to the head-mountable display. Additionally, by using remote devices, the HMD can be implemented without a dedicated text-input component, and so can reduce the size, weight, resource requirements, and complexity of the HMD.

### II. Example Wearable Computing Devices

Systems and devices in which example embodiments can be implemented will now be described in greater detail. In general, an example system can be implemented in or can take the form of a wearable computer (also referred to as a wearable computing device). In an example embodiment, a wearable computer can take the form of or include a head-mountable display (HMD).

An example system can also be implemented in or take the form of other devices, such as a mobile phone, among other possibilities. Further, an example system can take the form of non-transitory computer readable medium, which has program instructions stored thereon that are executable by a processor to provide the functionality described herein. An example system can also take the form of a device such as a wearable computer or mobile phone, or a subsystem of such a device, which includes such a non-transitory computer readable medium having such program instructions stored thereon.

A HMD can generally be any display device that is capable of being worn on the head and places a display in front of one or both eyes of the wearer. A HMD can take various forms such as a helmet or eyeglasses. As such, references to “eyeglasses” or a “glasses-style” HMD should be understood to refer to a HMD that has a glasses-like frame so that it can be worn on the head. Further, example embodiments can be implemented by or in association with a HMD with a single display or with two displays, which can be referred to as a “monocular” HMD or a “binocular” HMD, respectively.

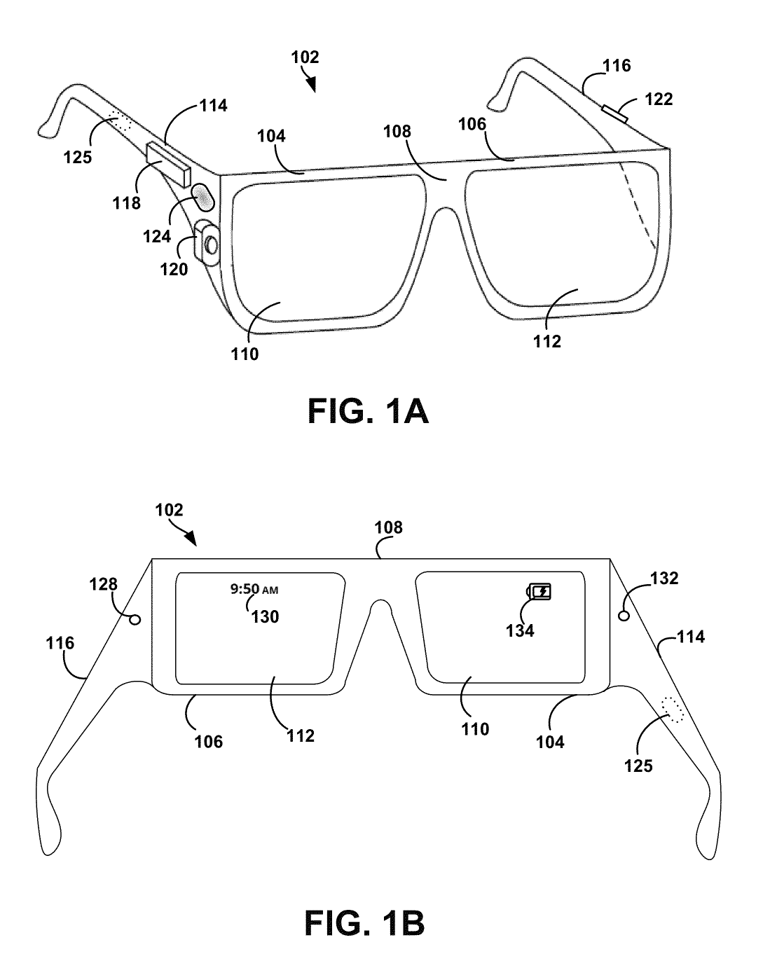

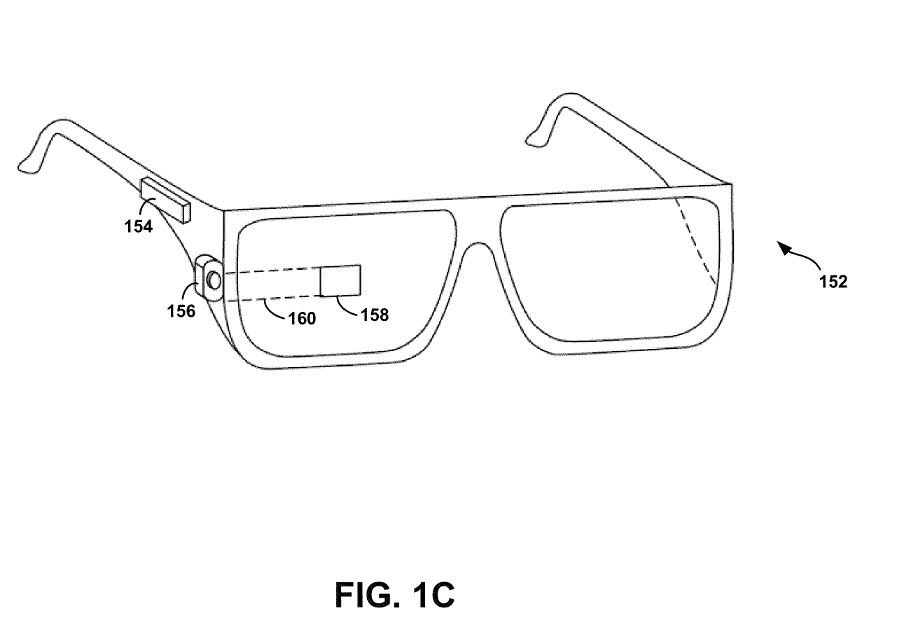

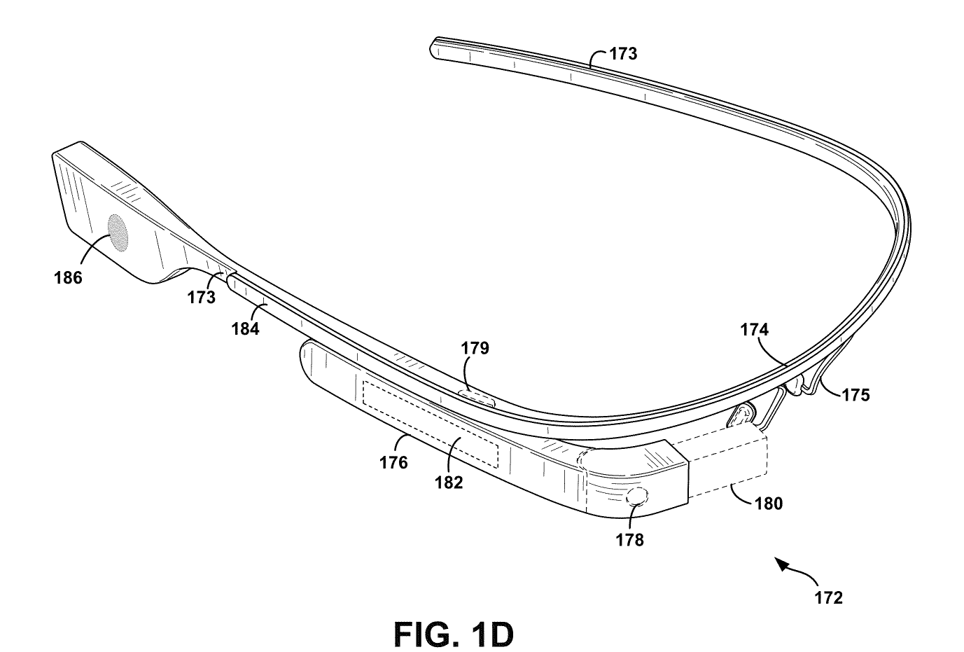

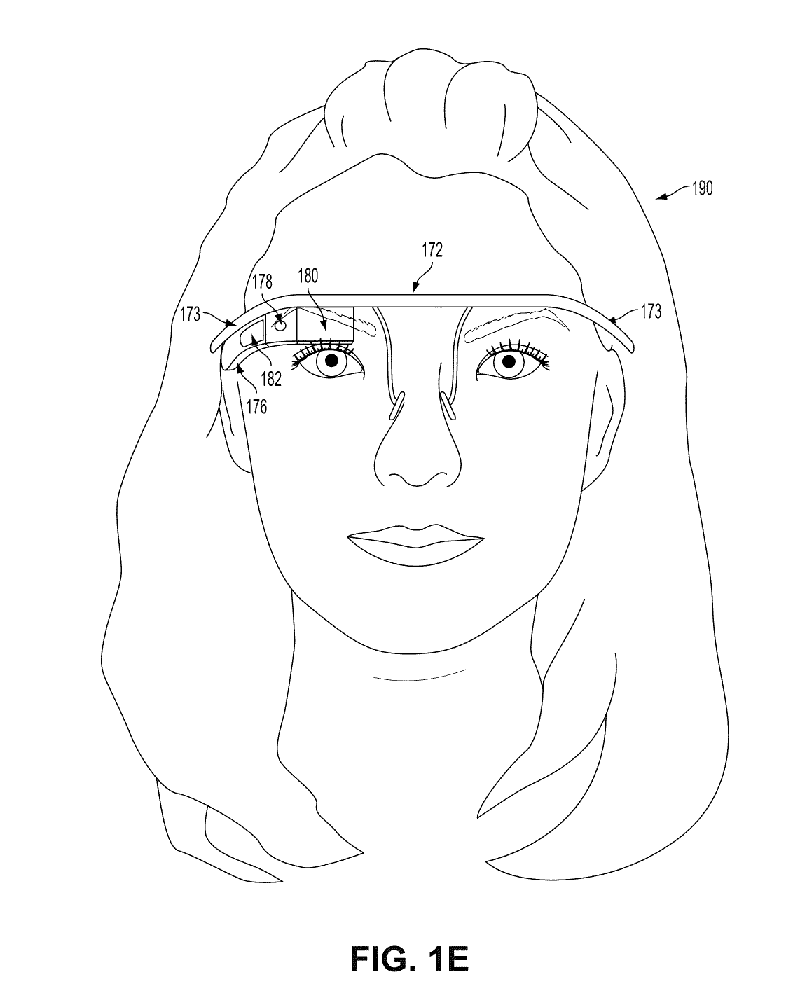

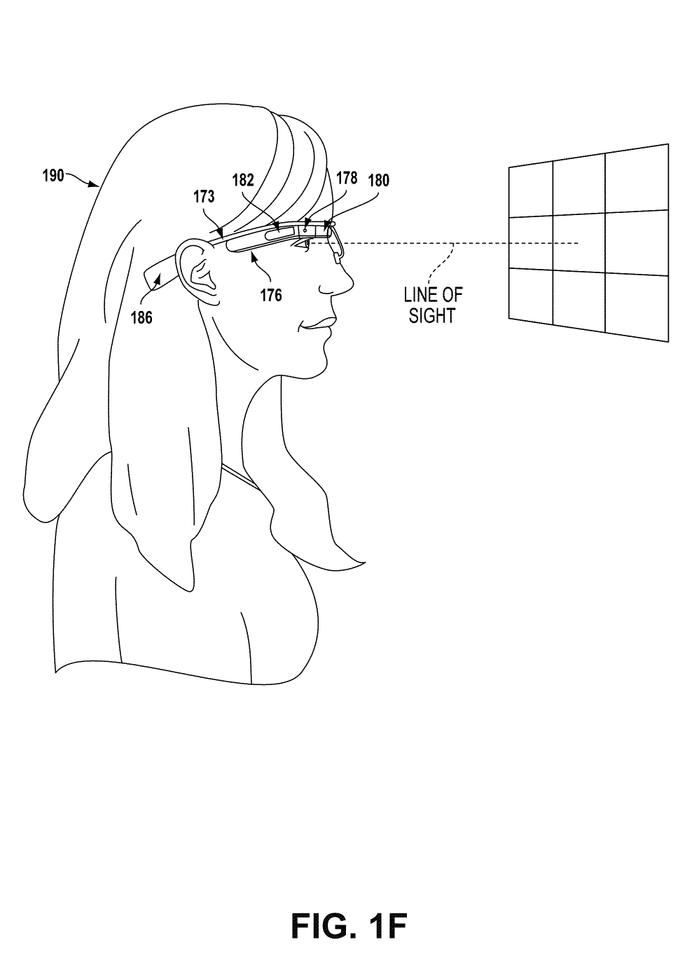

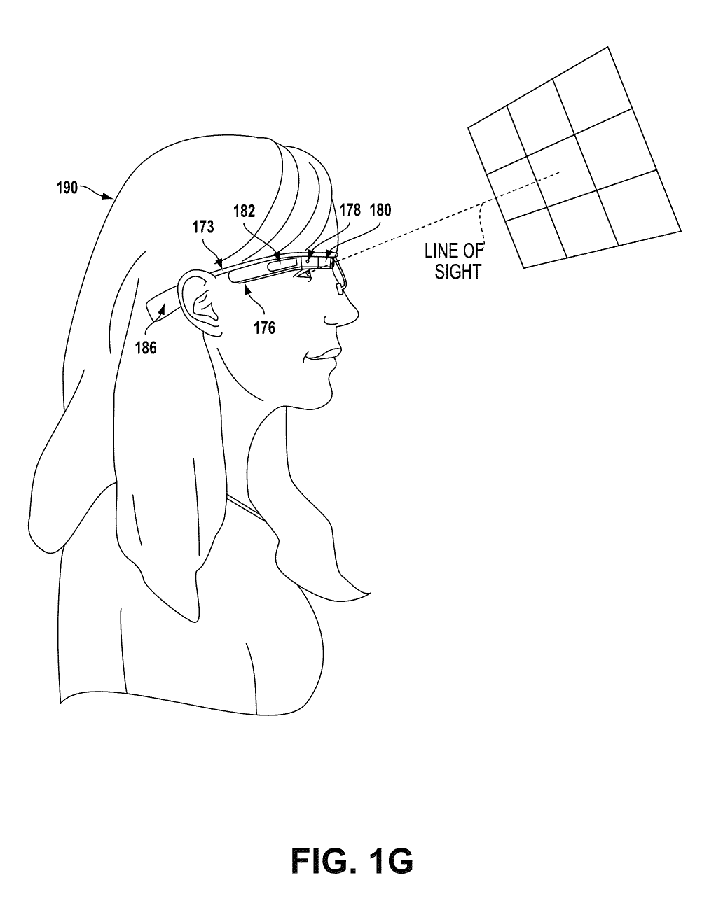

FIG. 1A illustrates a wearable computing system according to an example embodiment. In FIG. 1A, the wearable computing system takes the form of a HMD 102 (which can also be referred to as a head-mounted display). It should be understood, however, that example systems and devices can take the form of or be implemented within or in association with other types of devices, without departing from the scope of the invention. As illustrated in FIG. 1A, HMD 102 includes frame elements including lens-frames 104, 106 and a center frame support 108, lens elements 110, 112, and extending side-arms 114, 116. The center frame support 108 and the extending side-arms 114, 116 are configured to secure HMD 102 to a user's face via a user's nose and ears, respectively.

Each of the frame elements 104, 106, and 108 and the extending side-arms 114, 116 can be formed of a solid structure of plastic and/or metal, or can be formed of a hollow structure of similar material so as to allow wiring and component interconnects to be internally routed through HMD 102. Other materials can be possible as well.

One or more of each of the lens elements 110, 112 can be formed of any material that can suitably display a projected image or graphic. Each of the lens elements 110, 112 can also be sufficiently transparent to allow a user to see through the lens element. Combining these two features of the lens elements can facilitate an augmented reality or heads-up display where the projected image or graphic is superimposed over a real-world view as perceived by the user through the lens elements.

The extending side-arms 114, 116 can each be projections that extend away from the lens-frames 104, 106, respectively, and can be positioned behind a user's ears to secure HMD 102 to the user. The extending side-arms 114, 116 can further secure HMD 102 to the user by extending around a rear portion of the user's head. Additionally or alternatively, for example, HMD 102 can connect to or be affixed within a head-mounted helmet structure. Other configurations for a HMD are also possible.

HMD 102 can also include an on-board computing system 118, an image capture device 120, a sensor 122, and a finger-operable touch pad 124. The on-board computing system 118 is shown to be positioned on the extending side-arm 114 of HMD 102; however, the on-board computing system 118 can be provided on other parts of HMD 102 or can be remotely positioned from HMD 102 (e.g., the on-board computing system 118 could be wire- or wirelessly-connected to HMD 102). The on-board computing system 118 can include a processor and memory, for example. The on-board computing system 118 can be configured to receive and analyze data from the image capture device 120 and the finger-operable touch pad 124 (and possibly from other sensory devices, user interfaces, or both) and generate images for output by the lens elements 110 and 112.

The image capture device 120 can be, for example, a camera that is configured to capture still images and/or to capture video. In the illustrated configuration, image capture device 120 is positioned on the extending side-arm 114 of HMD 102; however, the image capture device 120 can be provided on other parts of HMD 102. The image capture device 120 can be configured to capture images at various resolutions or at different frame rates. Many image capture devices with a small form-factor, such as the cameras used in mobile phones or webcams, for example, can be incorporated into an example of HMD 102.

Further, although FIG. 1A illustrates one image capture device 120, more image capture devices can be used, and each can be configured to capture the same view, or to capture different views. For example, the image capture device 120 can be forward facing to capture at least a portion of the real-world view perceived by the user. This forward facing image captured by the image capture device 120 can then be used to generate an augmented reality where computer generated images appear to interact with or overlay the real-world view perceived by the user.

The sensor 122 is shown on the extending side-arm 116 of HMD 102; however, the sensor 122 can be positioned on other parts of HMD 102. For illustrative purposes, only one sensor 122 is shown. However, in an example embodiment, HMD 102 can include multiple sensors. For example, HMD 102 can include sensors 102 such as one or more gyroscopes, one or more accelerometers, one or more magnetometers, one or more light sensors, one or more infrared sensors, and/or one or more microphones. Other sensing devices can be included in addition or in the alternative to the sensors that are specifically identified herein.

The finger-operable touch pad 124 is shown on the extending side-arm 114 of HMD 102. However, the finger-operable touch pad 124 can be positioned on other parts of HMD 102. Also, more than one finger-operable touch pad can be present on HMD 102. The finger-operable touch pad 124 can be used by a user to input commands. The finger-operable touch pad 124 can sense at least one of a pressure, position and/or a movement of one or more fingers via capacitive sensing, resistance sensing, or a surface acoustic wave process, among other possibilities. The finger-operable touch pad 124 can be capable of sensing movement of one or more fingers simultaneously, in addition to sensing movement in a direction parallel or planar to the pad surface, in a direction normal to the pad surface, or both, and can also be capable of sensing a level of pressure applied to the touch pad surface. In some embodiments, the finger-operable touch pad 124 can be formed of one or more translucent or transparent insulating layers and one or more translucent or transparent conducting layers. Edges of the finger-operable touch pad 124 can be formed to have a raised, indented, or roughened surface, so as to provide tactile feedback to a user when the user's finger reaches the edge, or other area, of the finger-operable touch pad 124. If more than one finger-operable touch pad is present, each finger-operable touch pad can be operated independently, and can provide a different function.

In a further aspect, HMD 102 can be configured to receive user input in various ways, in addition or in the alternative to user input received via finger-operable touch pad 124. For example, on-board computing system 118 can implement a speech-to-text process and utilize a syntax that maps certain spoken commands to certain actions. In addition, HMD 102 can include one or more microphones via which a wearer's speech can be captured. Configured as such, HMD 102 can be operable to detect spoken commands and carry out various computing functions that correspond to the spoken commands.

As another example, HMD 102 can interpret certain head-movements as user input. For example, when HMD 102 is worn, HMD 102 can use one or more gyroscopes and/or one or more accelerometers to detect head movement. HMD 102 can then interpret certain head-movements as being user input, such as nodding, or looking up, down, left, or right. HMD 102 could also pan or scroll through graphics in a display according to movement. Other types of actions can also be mapped to head movement.

As yet another example, HMD 102 can interpret certain gestures (e.g., by a wearer's hand or hands) as user input. For example, HMD 102 can capture hand movements by analyzing image data from image capture device 120, and initiate actions that are defined as corresponding to certain hand movements.

As a further example, HMD 102 can interpret eye movement as user input. In particular, HMD 102 can include one or more inward-facing image capture devices and/or one or more other inward-facing sensors (not shown) that can be used to track eye movements and/or determine the direction of a wearer's gaze. As such, certain eye movements can be mapped to certain actions. For example, certain actions can be defined as corresponding to movement of the eye in a certain direction, a blink, and/or a wink, among other possibilities.

HMD 102 also includes a speaker 125 for generating audio output. In one example, the speaker could be in the form of a bone conduction speaker, also referred to as a bone conduction transducer (BCT). Speaker 125 can be, for example, a vibration transducer or an electroacoustic transducer that produces sound in response to an electrical audio signal input. The frame of HMD 102 can be designed such that when a user wears HMD 102, the speaker 125 contacts the wearer. Alternatively, speaker 125 can be embedded within the frame of HMD 102 and positioned such that, when HMD 102 is worn, speaker 125 vibrates a portion of the frame that contacts the wearer. In either case, HMD 102 can be configured to send an audio signal to speaker 125, so that vibration of the speaker can be directly or indirectly transferred to the bone structure of the wearer. When the vibrations travel through the bone structure to the bones in the middle ear of the wearer, the wearer can interpret the vibrations provided by BCT 125 as sounds.

Various types of bone-conduction transducers (BCTs) can be implemented, depending upon the particular implementation. Generally, any component that is arranged to vibrate HMD 102 can be incorporated as a vibration transducer. Yet further it should be understood that HMD 102 can include a single speaker 125 or multiple speakers. In addition, the location(s) of speaker(s) on the HMD can vary, depending upon the implementation. For example, a speaker can be located proximate to a wearer's temple (as shown), behind the wearer's ear, proximate to the wearer's nose, and/or at any other location where the speaker 125 can vibrate the wearer's bone structure.

FIG. 1B illustrates an alternate view of the HMD illustrated in FIG. 1A. As shown in FIG. 1B, the lens elements 110, 112 can act as display elements. HMD 102 can include a first projector 128 coupled to an inside surface of the extending side-arm 116 and configured to project a display 130 onto an inside surface of the lens element 112. Additionally or alternatively, a second projector 132 can be coupled to an inside surface of the extending side-arm 114 and configured to project a display 134 onto an inside surface of the lens element 110.

The lens elements 110, 112 can act as a combiner in a light projection system and can include a coating that reflects the light projected onto them from the projectors 128, 132. In some embodiments, a reflective coating may not be used (e.g., when the projectors 128, 132 are scanning laser devices).

In alternative embodiments, other types of display elements can also be used. For example, the lens elements 110, 112 themselves can include: a transparent or semi-transparent matrix display, such as an electroluminescent display or a liquid crystal display, one or more waveguides for delivering an image to the user's eyes, or other optical elements capable of delivering an in focus near-to-eye image to the user. A corresponding display driver can be disposed within the frame elements 104, 106 for driving such a matrix display. Alternatively or additionally, a laser or LED source and scanning system could be used to draw a raster display directly onto the retina of one or more of the user's eyes. Other possibilities exist as well.

FIG. 1C illustrates another wearable computing system according to an example embodiment, which takes the form of HMD 152. HMD 152 can include frame elements and side-arms such as those described with respect to FIGS. 1A and 1B. HMD 152 can additionally include an on-board computing system 154 and an image capture device 156, such as those described with respect to FIGS. 1A and 1B. The image capture device 156 is shown mounted on a frame of HMD 152. However, the image capture device 156 can be mounted at other positions as well.

As shown in FIG. 1C, HMD 152 can include a single display 158 which can be coupled to the device. The display 158 can be formed on one of the lens elements of HMD 152, such as a lens element described with respect to FIGS. 1A and 1B, and can be configured to overlay computer-generated graphics in the user's view of the physical world. The display 158 is shown to be provided in a center of a lens of HMD 152, however, the display 158 can be provided in other positions, such as for example towards either the upper or lower portions of the wearer's field of view. The display 158 is controllable via the computing system 154 that is coupled to the display 158 via an optical waveguide 160.

FIG. 1D illustrates another wearable computing system according to an example embodiment, which takes the form of a monocular HMD 172. HMD 172 can include side-arms 173, a center frame support 174, and a bridge portion with nosepiece 175. In the example shown in FIG. 1D, the center frame support 174 connects the side-arms 173. HMD 172 does not include lens-frames containing lens elements. HMD 172 can additionally include a component housing 176, which can include an on-board computing system (not shown), an image capture device 178, and a button 179 for operating the image capture device 178 (and/or usable for other purposes). Component housing 176 can also include other electrical components and/or can be electrically connected to electrical components at other locations within or on the HMD. HMD 172 also includes a BCT 186.

HMD 172 can include a single display 180, which can be coupled to one of the side-arms 173 via the component housing 176. In an example embodiment, the display 180 can be a see-through display, which is made of glass and/or another transparent or translucent material, such that the wearer can see their environment through the display 180. Further, the component housing 176 can include the light sources (not shown) for the display 180 and/or optical elements (not shown) to direct light from the light sources to the display 180. As such, display 180 can include optical features that direct light that is generated by such light sources towards the wearer's eye, when HMD 172 is being worn.

In a further aspect, HMD 172 can include a sliding feature 184, which can be used to adjust the length of the side-arms 173. Thus, sliding feature 184 can be used to adjust the fit of HMD 172. Further, a HMD can include other features that allow a wearer to adjust the fit of the HMD, without departing from the scope of the invention.

FIGS. 1E to 1G are simplified illustrations of HMD 172 shown in FIG. 1D, being worn by a wearer 190. As shown in FIG. 1F, when HMD 172 is worn, BCT 186 is arranged such that when HMD 172 is worn, BCT 186 is located behind the wearer's ear. As such, BCT 186 is not visible from the perspective shown in FIG. 1E.

In the illustrated example, the display 180 can be arranged such that when HMD 172 is worn, display 180 is positioned in front of or proximate to a user's eye when HMD 172 is worn by a user. For example, display 180 can be positioned below the center frame support and above the center of the wearer's eye, as shown in FIG. 1E. Further, in the illustrated configuration, display 180 can be offset from the center of the wearer's eye (e.g., so that the center of display 180 is positioned to the right and above of the center of the wearer's eye, from the wearer's perspective).

Configured as shown in FIGS. 1E to 1G, display 180 can be located in the periphery of the field of view of the wearer 190, when HMD 172 is worn. Thus, as shown by FIG. 1F, when the wearer 190 looks forward, the wearer 190 can see the display 180 with their peripheral vision. As a result, display 180 can be outside the central portion of the wearer's field of view when their eye is facing forward, as it commonly is for many day-to-day activities. Such positioning can facilitate unobstructed eye-to-eye conversations with others, as well as generally providing unobstructed viewing and perception of the world within the central portion of the wearer's field of view. Further, when the display 180 is located as shown, the wearer 190 can view the display 180 by, e.g., looking up with their eyes only (possibly without moving their head). This is illustrated as shown in FIG. 1G, where the wearer has moved their eyes to look up and align their line of sight with display 180. A wearer might also use the display by tilting their head down and aligning their eye with the display 180.

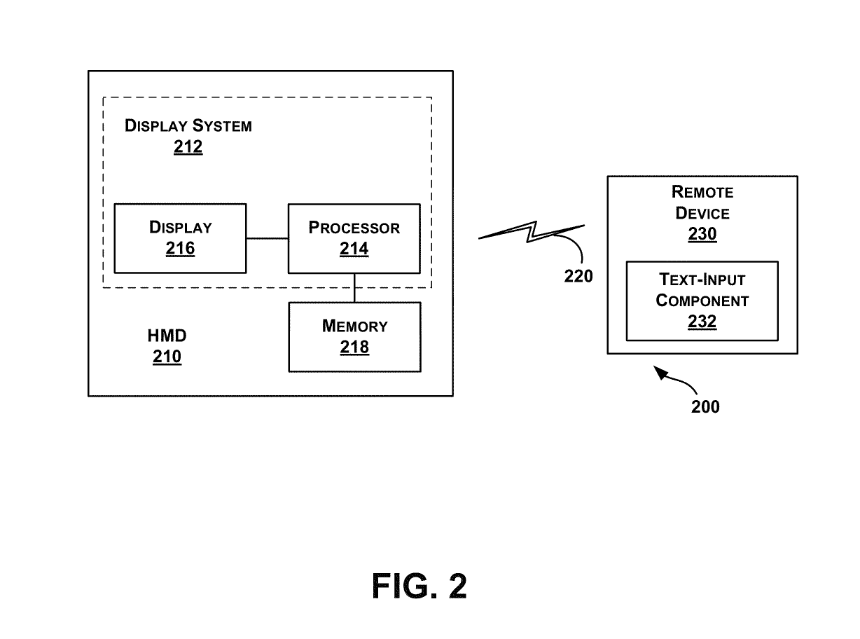

FIG. 2 illustrates HMD 210 configured for communication with remote device 230, according to an example embodiment. In an example embodiment, HMD 210 communicates with remote device 230 using communication link 220 (e.g., a wired or wireless connection). HMD 210 can be any type of device that can receive data and display information corresponding to or associated with the data. For example, HMD 210 can be a head-mounted display system, such as HMDs 102, 152, or 172 described with reference to FIGS. 1A to 1G.

Thus, HMD 210 can include a display system 212 comprising a processor 214 and a display 216. The display 210 can be, for example, an optical see-through display, an optical see-around display, or a video see-through display. The processor 214 can receive data from the remote device 230, and configure the data for display on the display 216. The processor 214 can be any type of processor, such as a micro-processor or a digital signal processor, for example.

HMD 210 can further include on-board data storage, such as memory 218 coupled to the processor 214. The memory 218 can store software that can be accessed and executed by the processor 214, for example.

Remote device 230 can be any type of computing device or transmitter including a laptop computer, a mobile telephone, or tablet computing device, etc., that is configured to transmit data to the device 210. Remote device 230 and HMD 210 can contain hardware to enable the communication link 220, such as processors, transmitters, receivers, antennas, etc.

Further, remote device 230 can take the form of or be implemented in a computing system that is in communication with and configured to perform functions on behalf of a client device, such as HMD 210. Such a remote device 230 can receive data from another HMD 210 (e.g., HMD 102, 152, or 172 or a mobile phone), perform certain processing functions on behalf of the device 210, and then send the resulting data back to device 210. This functionality can be referred to as “cloud” computing.

One example processing function for remote device 230 to perform on behalf of HMD 210 is a text entry function. In some embodiments, HMD 210 can be configured without a text-input component. In other embodiments, HMD 210 can be configured to enter text but entering text may be easier, more efficient, and/or more reliable using text-input component 232.

To aid in text entry for HMD 210, remote device 230 can be configured with text-input component 232, which can be a keyboard, touch screen, ring keyboard, bracelet keyboard, keypad, text-input application, or another component configurable to readily enter text. Once the text is entered, the text can be sent from remote device 230 to HMD 210; e.g., using communication link 220.

In FIG. 2, communication link 220 is illustrated as a wireless connection; however, wired connections can also be used. For example, communication link 220 can be a wired serial bus such as a universal serial bus or a parallel bus. A wired connection can be a proprietary connection as well. The communication link 220 can also be a wireless connection using, e.g., Bluetooth® radio technology, communication protocols described in IEEE 802.11 (including any IEEE 802.11 revisions), Cellular technology (such as GSM, CDMA, UMTS, EV-DO, WiMAX, or LTE), or Zigbee® technology, among other possibilities. The remote device 230 can be accessible via the Internet and can include a computing cluster associated with a particular web service (e.g., social-networking, photo sharing, address book, etc.).

### III. Example Scenarios for Remote Text Entry

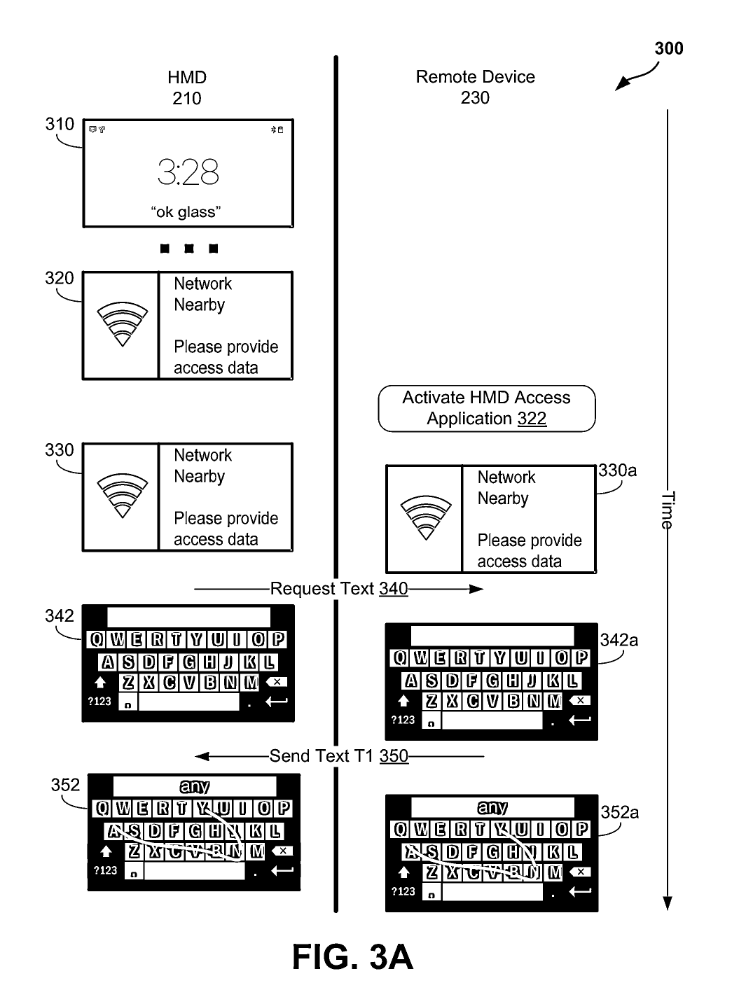

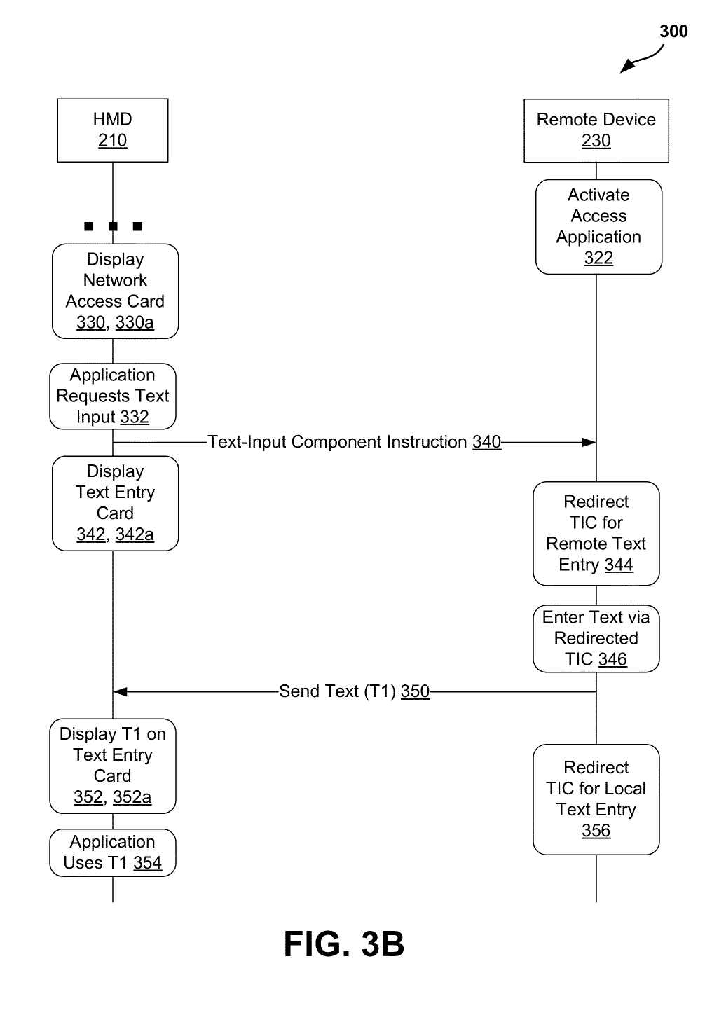

FIGS. 3A and 3B illustrate scenario 300 for communicating text from remote device 230 previously requested by HMD 210, according to an example embodiment. FIG. 3A illustrates that scenario 300 begins at 310 with HMD 210 displaying a “card” or screen, such as the depicted home card.

FIG. 3A shows that, at 320, HMD 210 detects signals from a wireless network, such as a Wi-Fi, Bluetooth, or other wireless network. In response, HMD 210 can display a “Network Nearby” card to indicate a wireless network is potentially accessible and to make a request to “provide access data”.

At 322, an access application of remote device 230 is activated. In some cases, activation of the access application can include starting the access application, perhaps based on user input to remote device. In other cases, the access application can be started but inactive; e.g., asleep, and so activation of the access application can include awakening the access application from an inactive state. In still other cases, remove device 230 can already be activated at 322.

In scenario 300, the access application of remote device 230 is configured to receive a displayed card from HMD 210 and display the received card using remote device 230; i.e., mirror a display of HMD 210. Then, at 330, HMD 210 continues to display the network access card, and at 330a, the access application displays the network access card using remote device 230.

FIG. 3B shows that, after displaying the network access card, an application of HMD 210 can request text input at 332. After requesting text input, FIGS. 3A and 3B each show that HMD 210 sends text-input component instruction 340 to remote device 230. Then, at 342, HMD 210 displays a text entry card with a keyboard, and at 342a, remote device 230 also displays the text entry card.

FIG. 3B shows that, at 344, in response to text-input component instruction 340, remote device 230 can provide a text-input interface or text-input component (TIC), such as text-input component 232 associated with remote device 230, for use by HMD 210.

In scenario 300, the text-input component at least can be directed for remote entry or for local entry. When directed for remote entry, text received by text-input component can be obtained on behalf of a device other than remote device 230; e.g., HMD 210. When directed for local entry, text received by text-input component can be obtained for use by remote device 230. In some cases, remote device 230 can provide the text-input component for use by HMD 210 by redirecting text entered by a text-input component of remote device 230 for remote text entry on behalf of HMD 210.

In some embodiments, the text-input component can be directed for dual entry;

that is, received text can be provided both the remote device 230 and a device other than remote device 230. In some other embodiments, the text-input component of remote device 230 can be configured to switch between local entry and remote entry. Other possibilities for text-input direction are possible as well; e.g., direction to a log or other file, or direction to more than two outputs.

FIG. 3B shows, at 346, the requested text T1 can be entered using the redirected text-input component of remote device 230. T1 can be made up of characters. In some embodiments, T1 can be screened to accept only certain types of characters (e.g., numeric characters only, alphanumeric characters only) to process some characters locally (e.g., handle backspace characters by deleting a prior character from the text), and/or to not accept other characters (e.g., reject punctuation symbols from numeric only text). In particular embodiments, T1 can be screened based on information in request text message 340 or other information provided by HMD 210 to 230; e.g., screening information in request text message indicating a “numeric screen”, “alphanumeric screen”, or other type of textual screen. Many other screening examples are possible as well.

FIGS. 3A and 3B each show that, T1 can be sent to HMD 210 in send text message 350. In scenario 300, T1 can be provided from the text-input component to the access application of remote device 230, and the access application then can send T1 as part of send text message 350.

Upon reception of send text message 350, HMD 210 can extract text T1 from send text message 138 for use. In scenario 300, HMD 210 can update the text entry card to show text T1 that has been received. FIG. 3A shows that T1 is the word “any” as displayed in the text entry card at 352 both using a display of the text “any” near the top of the card and using a text-input path tracing the word any, as shown on the keyboard of the card. At 352a, the updated text-input card can be provided to and displayed by remote device 230. In other scenarios, T1 is not displayed by either HMD 210 or remote device 230.

FIG. 3B shows that, after displaying text T1 at 352, 352a, the application of HMD 210 that requested text at 332 can use received T1 at 354. For example, if T1 is or includes network access information; e.g., network identifier (ID), user ID, password, then a network access application of HMD 210 can use T1 to attempt access to a network; e.g., the network whose signals were detected at 320. As another example, if T1 is requested for a messaging application of HMD 210, the messaging application can use T1; e.g., as part of a message or to specify an addressee of a message. Many other examples of utilizing text are possible as well. In some scenarios, the application of HMD 210 can utilize T1 prior to, or at the same time, that text T1 is displayed. After T1 is utilized at 354, scenario 300 can be completed.

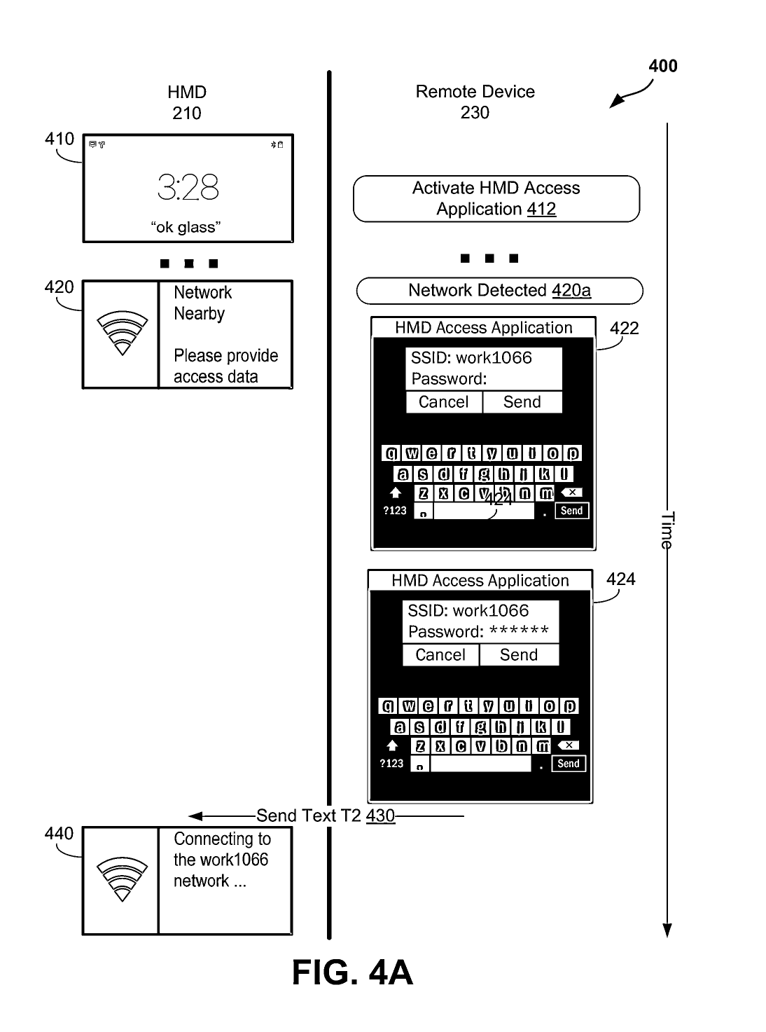

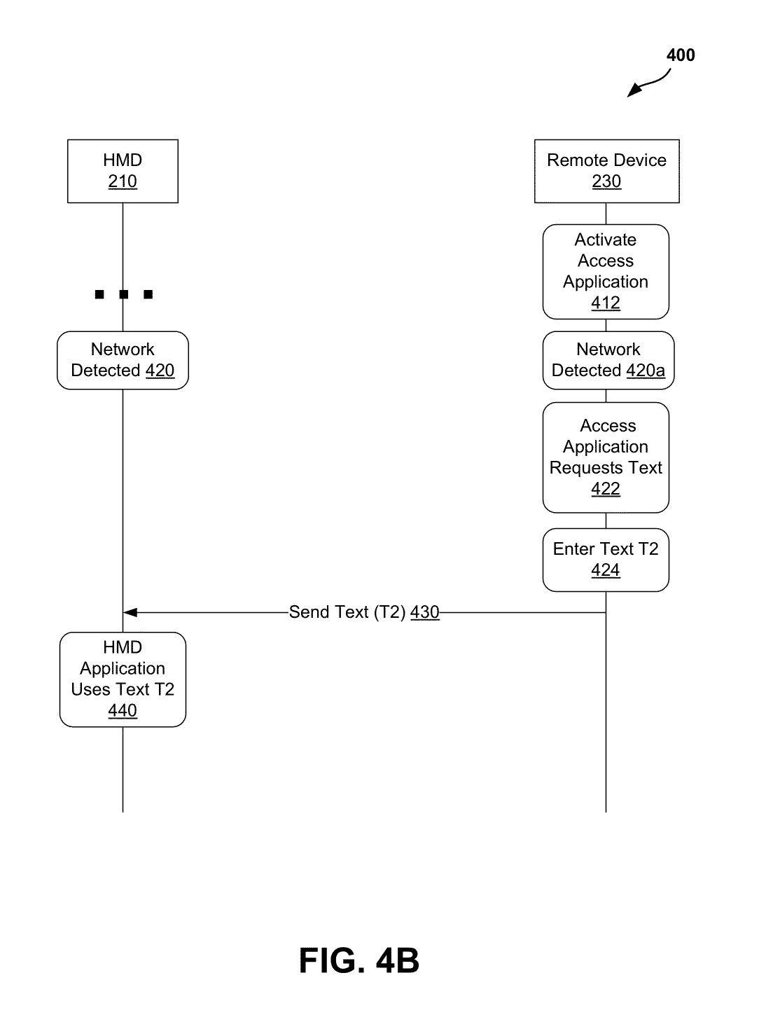

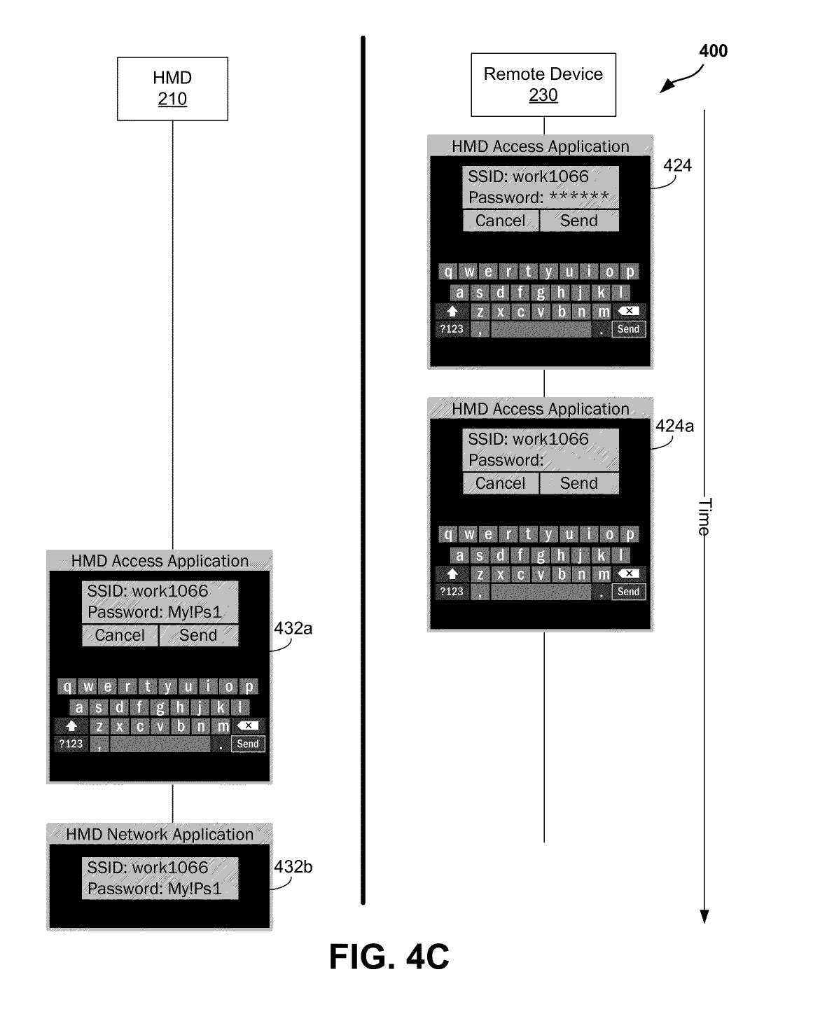

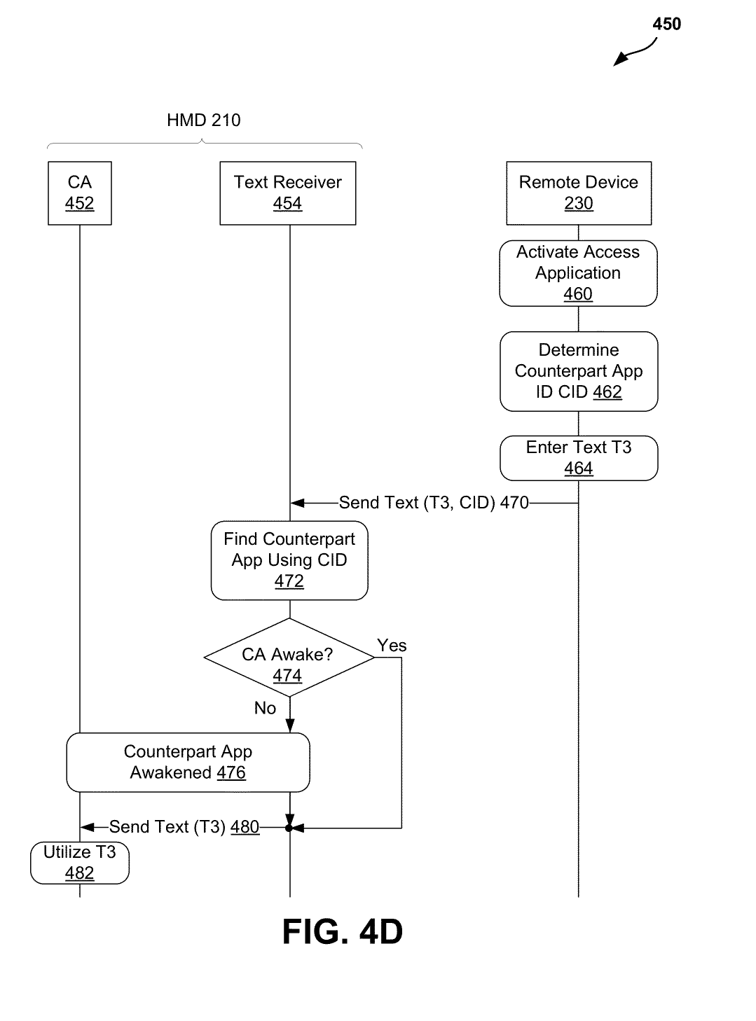

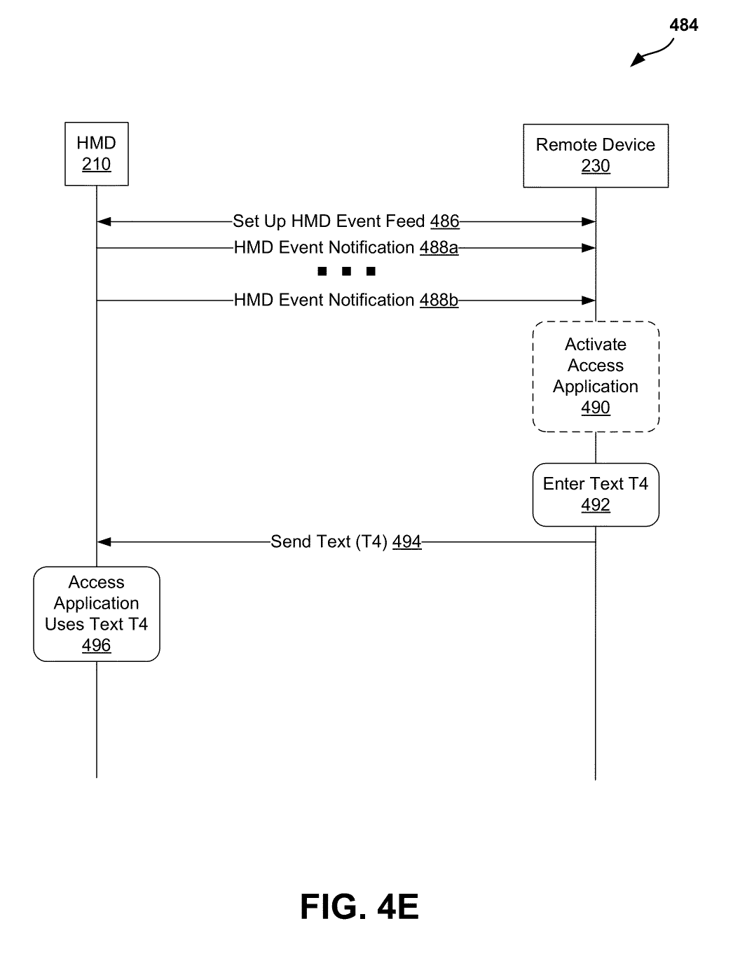

FIGS. 4A and 4B illustrate scenario 400 for communicating text from remote device 230 not previously requested by HMD 210, according to an example embodiment. FIG. 4A illustrates that scenario 400 begins at 410 with HMD 210 showing a “card” or display screen, such as the depicted home card. At 412, an access application of remote device 230 is activated, such as discussed above at least in the context of block 322 of scenario 300.

FIGS. 4A and 4B each show that, at 420, HMD 210 detects signals from a wireless network, such as a Wi-Fi, Bluetooth, or other wireless network. In response, HMD 210 can display a “Network Nearby” card, such as shown at 420 in FIG. 4A, to indicate a wireless network is potentially accessible and to make a request to “provide access data”.

FIGS. 4A and 4B each show that, at 420a, remote device 230 can also detect the signals from the wireless network. At 422, FIGS. 4A and 4B each show that the access application of remote device 420 can request text for use by HMD 210. For example, remote device 230 can determine that an event, such as detecting a network at 420a, can be applicable to HMD 210. For example, remote device 230 and HMD 210 can be in close proximity; e.g., within a few inches or feet of each other. As such, remote device 230 detecting signals from an accessible network can indicate to remote device 230 that the network may also be accessible to WCT 210. Further, remote device 230 can determine that the applicable event can involve text; e.g., to access the network, a user name and/or password may have to be provided.

After determining that the application event related to HMD 210 can involve text, remote device 230 can request text for HMD 210. As shown in FIG. 4A, the access application can request text, at least in part by displaying a “HMD Access Application” dialog to request text entry for HMD 210 at remote device 230. The HMD Access Application dialog can display a keyboard as shown in FIG. 4A.

In some embodiments, remote device 230 can be configured with a touch screen or other device that accepts touch input. In these embodiments, the keyboard of the HMD Access Application dialog can be displayed so that the touch screen, accompanied by the displayed keyboard, can used to enter the requested text. In other embodiments, the requested text can be provided using a text-input component other than a touch screen; e.g., a keyboard or keypad.

In still other embodiments, a text-input component can be redirected for remote entry while HMD Access Application dialog is displayed on remote device 230—redirection of text-input components is discussed above at least in the context of FIGS. 3A and 3B.

The HMD Access Application dialog can provide information about the requested text. For example, FIG. 4A shows at 422 that the HMD Access Application dialog displays a “SSID” (Service Set IDentifier) that indicates that the requested text is related to a “work1066” Wi-Fi network. The HMD Access Application dialog also displays a “Password” prompt to specifically request text for a password; i.e., an access password for the work1066 network.

At 424 of FIGS. 4A and 4B, text T2 is entered at remote device 230 and provided to the access application. Text T2 can be screened to include or exclude characters, such as discussed above at least in the context of FIGS. 3A and 3B.

In scenario 400, the HMD Access Application dialog can be updated as the requested text is entered as text T2 in a character-by-character fashion. Then, as each character is provided, the HMD Access Application dialog can be updated to display the provided character. As another example, character(s) other than provided characters can be displayed as text is provided to the access application, such as the asterisks “*****” shown at 424 of FIG. 4A. Each asterisk can indicate a provided character that is being masked from output, as the provided text is for a password.

In some embodiments, provided text can be displayed based on the type of input, such as the asterisks shown at 424 that are used to indicate that password text has been provided. As other examples, provided text can be “echo printed” or displayed as received; e.g., for an ordinary text type, or not displayed at all; e.g., for passwords and/or other types of text considered to be secure or for establishing permissions/access. Other examples of displaying received text based on a type of text (or input) associated with the received text are possible as well.

After requested text T2 is provided to the access application of remote device 230, FIGS. 4A and 4B each show that, scenario 400 continues with T2 being sent to HMD 210 in send text message 430. As shown in both FIGS. 4A and 4B, send text message 430 can include T2.

Upon reception of send text message 350, scenario 400 can continue with HMD 210 extracting text T2 from send text message 430 and then, at 440, HMD 210 using text T2.

For example, after extracting text T2, HMD 210 can provide T2 to an application executing on HMD 210, so that the application can utilize T2. In scenario 400, as shown in FIG. 4A, T2 can be used as a password for the “work1066” network. After the application of HMD 210 utilizes text T2, scenario 400 can be completed.

FIG. 4C depicts additional examples of the HMD Access Application dialog and display of received text. As part of scenario 400, at 424, T2 is entered and corresponding asterisks (“*”'s) are displayed, as shown in both FIGS. 4A and 4C. As part of an alternative to scenario 400, T2 is also entered at 424a In response, the HMD Access Application dialog at 424a does not display any indication of received text e.g., there are no “*” or other characters shown as a “Password” of the HMD Access Application dialog.

After T2 is provided to HMD 210 at 430, the text can be displayed on HMD 210. As indicated in FIG. 2, HMD 210 can include display 216. In some embodiments, display 216 can be difficult or impossible to observe by an entity other than an entity wearing HMD 210. Then, it is difficult or impossible for an entity to observe text, including passwords, displayed on display 216. As such, a password or other text related to private information (e.g., account numbers, other identifying information) entered by the wearer can be displayed as plain text without substantially increasing security risks.

In some embodiments, passwords can be displayed in an obscured manner, such as using asterisks or not being displayed at all on remote device 230 while being displayed as plain text on HMD 210. An alternative of scenario 400 shown in FIG. 4C at 432a, indicates that a password provided to HMD 210 as T2 can be displayed as plain text using HMD 210 as “My!Ps1”. Then, if there is a typographical error in the password; e.g., “My!Ps2” is entered rather than “My!Ps1”, the wearer of HMD 210 can review the password presented on display 216, correct the password (if necessary), and then submit the (corrected) password to a network. At 432b, a dialog other than the HMD Access Application dialog can be presented using HMD 210 to show T2 as plain text.

In some embodiments, all text provided to HMD 210 can be displayed as plain text. In other embodiments, text provided to HMD 210 can be displayed as plain text, except under certain conditions; e.g., a condition that an access application, such as the HMD Access Application of FIG. 3D, is active. In that condition, the access application mirrors a display of HMD 210 and so text displayed as plain text using HMD 210 may be displayed using remote device 230. As displaying text on remote device 230 can be a security risk, displaying text as plain text on HMD 210 can be inhibited when an access application is active. Another condition can be a condition that a display of HMD 210, such as display 216, is being mirrored. Under that condition, use of an access application that does not mirror a display of HMD 210, such as the HMD Access Application of FIG. 4A, would lead to text provided to HMD 210 remaining displayable as plain text.

At both 432a and 432b, text T2 displayed using HMD 210 as plain text is displayed differently than displayed on remote device 230. As shown in both FIGS. 4A and 4C, remote device 230 shows T2 using asterisks as at 424 or does not display T2 as at 424a. In other scenarios, text displayed on remote device 230 can be displayed, but not displayed on HMD 210; e.g., FIG. 4A shows that text T2 is shown as asterisks at 424, sent to HMD 210 at 430, and T2 is not displayed by HMD 210 at 440. Other conditions and examples for displaying text differently are possible as well.

In some scenarios, applications of HMD 210 may not be awake when the text is actually provided; e.g., the text may be delayed in arriving and so the application may be put to sleep or otherwise terminated in the interim, perhaps to save power or other resources of HMD 210. In these scenarios, a text receiver application of HMD 210 can receive the text on behalf of the (sleeping) application, ensure the application is awakened, and then provide the text to the awakened application.

FIG. 4D illustrates scenario 450 for communicating text from remote device 230 not previously requested by HMD 210, according to an example embodiment. Scenario 450 begins at 460 with an access application of remote device 230 being activated, such as discussed above at least in the context of block 322 of scenario 300.

At 462, an identifier CID of a counterpart application (CA) 452 for HMD 210 is determined at the access application of remote device 230. At 464, text T3 is entered at remote device 230, such as discussed above regarding at least scenarios 300 and 400 and at least FIGS. 3A-4B.

As shown in FIG. 4D, scenario 450 can continue with text T3 being sent from remote device 230 to HMD 210 as part of send text message 470. In some embodiments, such as shown in FIG. 4D, send text message 470 can also include identifier CID of counterpart application 452 of HMD 210.

Send text message 470 can be received by text receiver 454; e.g., a thread, process, application, or other software executing on HMD 210 configured to receive text; i.e., in send text messages, and provide the received text to a destination application (or other software) of HMD 210.

In scenario 450, text receiver 454 can, at 472, determine a destination application based on the counterpart identifier CID provided in send text message 470. For example, each application of HMD 210 that may receive text from remote device 230 can have a predetermined identifier that is also known at remote device 230. Then, when text is destined for a particular application of HMD 210, the access application of remote device 230 can look up or otherwise determine the identifier for the particular application and insert the identifier for the particular application in a send text message for providing the text; e.g., identifier CID of counterpart application 452 inserted into send text message 470 providing T3 to HMD 210.

As shown in FIG. 4D, scenario 450 continues at 474 with text receiver 454 determining whether counterpart application 452, identified using identifier CID, is awake. If counterpart application 452 is not awake, scenario 450 continues at 476 with text receiver 454 either directly or indirectly awakening counterpart application 452. Once text receiver 454 determining that counterpart application 452 is awake, scenario 450 continues with text receiver 454 providing text T3 to counterpart application 452; e.g., using send text message 480 as shown in FIG. 4D. Upon reception of text T3, counterpart application 452 can utilize text T3 as shown at 482 of scenario 450. After T3 is utilized by counterpart application 452, scenario 450 can be completed.

In other embodiments not shown in FIG. 4D, an application of HMD 210 requesting text to be provided by remote device 230 can identify itself or otherwise be identified to the access application of remote device 230 prior to receiving text; i.e., the HMD application can register with the access application for text delivery. As part of the identification process, the registered application can provide an identifier equivalent to the identifier CID of counterpart application, and this equivalent identifier can be provided as part of a send text message just as identifier CID is provided in send text message 470. Text can be provided to the last registered application of HMD 210 until the application de-registers itself with the access application and/or until another application registers itself with the access application. In some cases, no application may be registered with the access application; then, the text can be provided to a default application, such as text receiver 454, or perhaps discarded.

In still other embodiments not shown in FIG. 4D, an application of HMD 210 requesting text to be provided by remote device 230 can identify itself or otherwise be identified to text receiver 454 prior to receiving text; i.e., the HMD application can register with text receiver 454 for text delivery. In these embodiments, the access application of remote device 210 can be configured not to provide the identifier of the registered application; rather, all text can be delivered to text receiver 454 and text receiver 454 can deliver the text to the registered application. Text provided to text receiver 454 can be provided (forwarded on) to the last registered application of HMD 210 until the application de-registers itself with text receiver 454 and/or until another application registers itself with text receiver 454. In some cases, no application may be registered with text receiver 454, then, the text can be provided to a default application or perhaps discarded.

FIG. 4E illustrates scenario 484 for communicating text from remote device 230 not previously requested by HMD 210, according to an example embodiment. Scenario 485 begins at 486 with HMD 210 and remote device 230 establishing an HMD Event Feed. The HMD Event Feed can include one or more messages related to events of HMD 210. Example events of HMD 210 include, but are not limited to, an event of HMD 210 being powered up, an event of HMD 210 being powered down, an event of a software or hardware failure on HMD 210, an event of HMD 210 detecting network signals, an event of HMD 210 displaying a card, an event of HMD 210 requesting input, an event of HMD 210 receiving input, an event of a message being sent by HMD 210, an event of a message being received at HMD 210, an event of HMD 210 generating output other than displaying a card, and event related to an environment of HMD 210. Many other example events are possible as well.

Once established, HMD Event Feed can provide notifications of HMD events, such as HMD Event Notifications 488a and 488b. Upon receipt of a HMD event notification, remote device 230 can examine the HMD event notification and determine whether text is required by HMD 210 in response to a HMD event corresponding to the HMD event notification.

For example, in scenario 484, HMD Event Notification 488a can notify remote device 230 that HMD 210 has detected a network, such as the “work1066” network discussed above in the context of scenario 400. Upon examination of HMD Event Notification 488a, remote device 230 can determine that HMD 210 may require text for a password to access the detected network. As another example, remote device 230 can receive an event that an application of HMD 210 has requested input, such as a web browser requesting input for a network address; e.g., a uniform resource locator (URL) or Internet Protocol (IP) address.

Then, at 490, remote device 230 can optionally determine whether an access application is active on the remote device. If the access application is not active, remote device 230 can activate the access application, as discussed above in the context of FIGS. 4A, 4B, and 4D.

At 492, text T4 is entered at remote device 230, such as discussed above regarding at least scenarios 300, 400, and 450, and at least FIGS. 3A-4B and 4D. As shown in FIG. 4E, scenario 484 can continue with text T4 being sent from remote device 230 to HMD 210 as part of send text message 494. In some embodiments, such as shown in FIG. 4E, send text message 494 can also include identifier CID of counterpart application 452 of HMD 210.

Send text message 494 can be received HMD 210 using the techniques discussed above in the context of scenarios 300, 400, and 450. Upon reception of text T4, HMD 210 can utilize text T4 as shown at 496 of scenario 484. After T4 is utilized, scenario 496 can be completed.

### IV. Example Methods of Operation

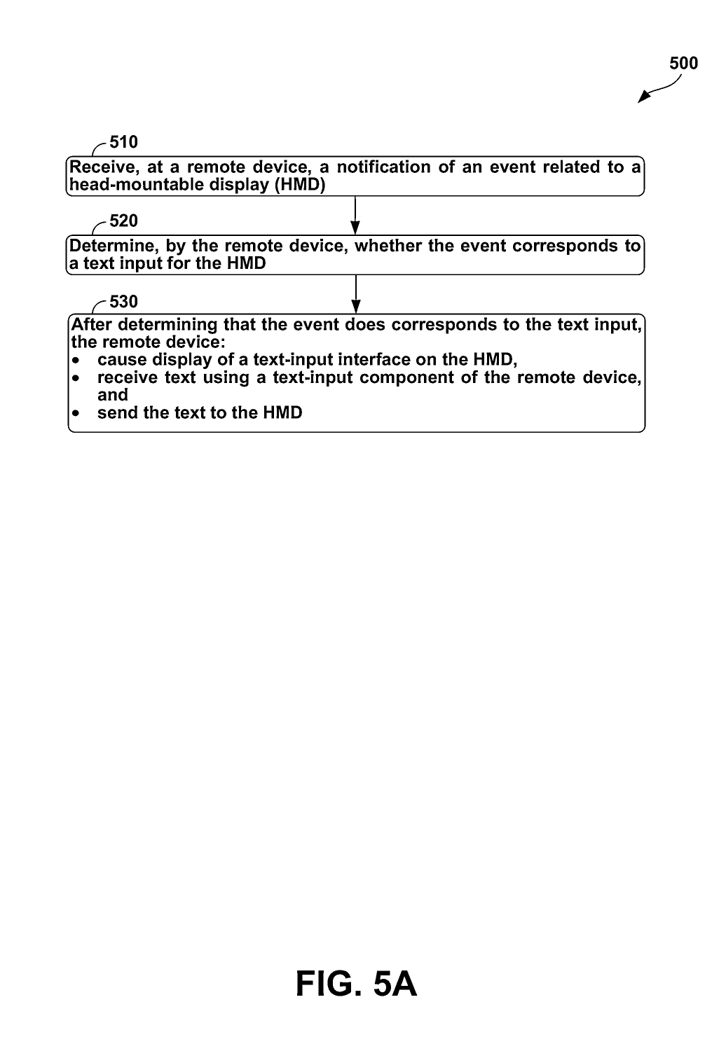

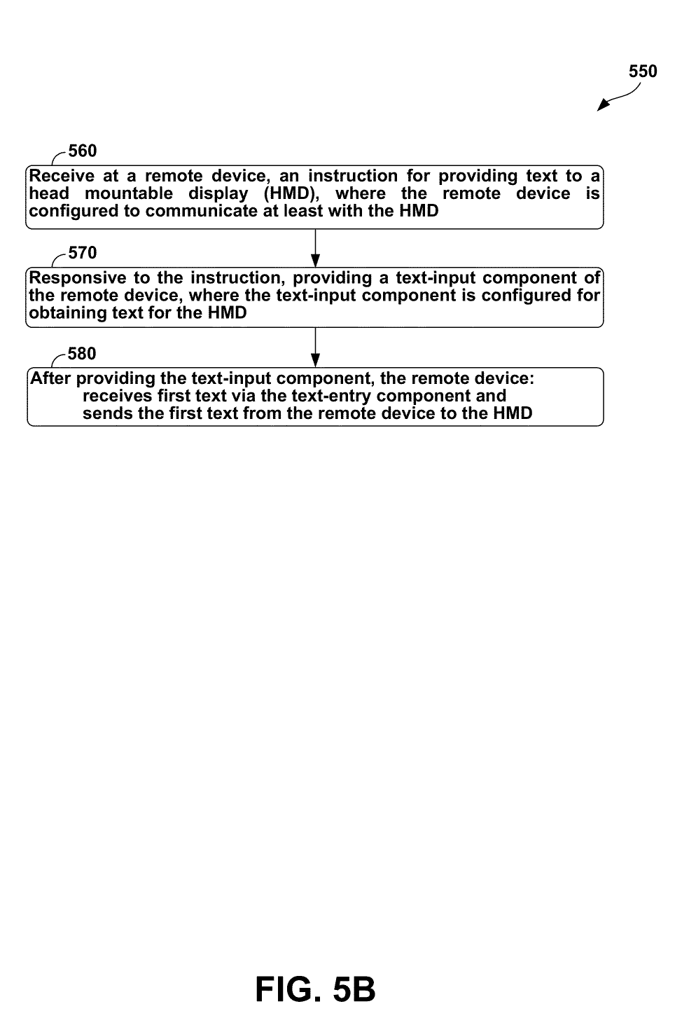

FIG. 5A is a flow chart of method 500, according to an example embodiment. In FIG. 5A, method 500 is described by way of example as being carried out by a remote device, such as remote device 230, that is associated with a computing device, such as HMD 210. HMD 210 can include a head-mounted display as discussed above. The HMD may include, or be, a wearable computing device.

Method 500 can begin at block 510. At block 510, a remote device can receive a notification of an event that is a related to the HMD, such as discussed above in the context of at least FIGS. 4A-4E. In some embodiments, the remote device can be a computing device selected from the group consisting of a smart phone, a desktop computing device, and a laptop computing device, such as discussed in the context of at least FIGS. 2-4C.

At block 520, the remote device can determine whether the event corresponds to a text input for the HMD, such as discussed above in the context of at least FIGS. 4A-4E.

At block 530, after determining that the event does correspond to the text input, the remote device can: cause display of a text-input interface on the HMD, receive text via a text-input component of the remote device, and send the text to the HMD.

In some embodiments, the text-input component of the remote device can include a physical keyboard, such as discussed above in the context of at least FIGS. 3A-4C. In other embodiments, the text-input component can include a text-input application configured for entering at least the text at the remote device, such as discussed above in the context of at least FIGS. 3A-4C. In still other embodiments, receiving text can include, in response to receiving the text, displaying the received text on the remote device, such as discussed above in the context of at least FIGS. 3A and 4A. In yet other embodiments, receiving text can include: in response to receiving the text, displaying the received text as plain text on the HMD; and, in response to receiving the text, providing a display without the received text on the remote device, such as discussed above in the context of at least FIGS. 4A-4C.

In even other embodiments, causing the display of the text-input interface on the HMD includes causing a display of the text-input interface on the remote device, such as discussed above in the context of at least FIG. 3A.

In yet other embodiments, sending the text to the HMD can include: sending a send text message with the text to the HMD, where the send text message is configured to identify a source application of the text. In particular of these embodiments, method 500 can further include: receiving the send text message at the HMD; determining, on the HMD, a counterpart application of the HMD to the source application; and providing the text to the counterpart application of the HMD, such as discussed above in the context of at least FIG. 4C.

In more particular of these embodiments, providing the text to the counterpart application of the HMD can include: determining whether the counterpart application is active on the HMD; after determining that the counterpart application is not executing on the HMD, responsively making the counterpart application active on the HMD; and after making the counterpart application active on the HMD, providing the text to the counterpart application, such as discussed above in the context of at least FIG. 4C.

In some embodiments, method 500 can further include the remote device: determining that a network is accessible by the remote device; determining whether the network being accessible corresponds to text input for the HMD, and after determining that the network being accessible corresponds to the text input for the HMD, determining that text is to be provided to the HMD, such as discussed above in the context of at least FIGS. 4A and 4B.

In other embodiments, the text can include one or more characters. In these embodiments, method 500 can further include: determining a set of valid input characters and determining whether each character of the text is in the set of valid input characters, such as discussed above in the context of at least FIG. 3A.

FIG. 5B is a flow chart of method 550, according to an example embodiment. In FIG. 5A, method 550 is described by way of example as being carried out by a remote device, such as remote device 230, that is associated with a HMD, such as HMD 210. The HMD may include, or be, a wearable computing device.

Method 550 can begin at block 560. At block 560, the remote device can receive an instruction for providing text to a HMD, where the remote device is configured to communicate with at least the HMD, such as discussed above in the context of at least FIGS. 3A-3B. In some embodiments, the remote device can be a computing device selected from the group consisting of a smart phone, a desktop computing device, and a laptop computing device, such as discussed above at least in the context of FIG. 2.

At block 570, responsive to the instruction, the remote device can provide a text-input component of the remote device, where the text-input component is configured for obtaining text for the HMD, such as discussed above at least in the context of FIG. 3B.

At block 580, after providing the text-input component, the remote device can receive first text via the text-input component and can send the first text to the HMD, such as discussed above at least in the context of FIG. 3B. In some embodiments, sending the first text to the HMD can include sending the first text to the HMD using a send text message, where the send text message is configured to identify a particular application as a source application of the first text, such as discussed above in the context of at least FIG. 4C.

In particular embodiments, method 550 can further include: receiving the send text message at the HMD; determining, on the HMD, that the source application of the first text is the particular application; determining a counterpart application of the HMD to the source application; and providing the first text to the counterpart application of the HMD, such as discussed above in the context of at least FIG. 4C. In more particular embodiments, providing the first text to the counterpart application of the HMD can include: determining whether the counterpart application is active on the HMD; after determining that the counterpart application is not executing on the HMD, responsively executing the counterpart application on the HMD; and after executing the counterpart application on the HMD, providing the first text to the executing counterpart application, such as discussed above in the context of at least FIG. 4C.

In other embodiments, method 550 can also include that the remote device can, after sending the first text to the HMD: configure the text-input component to obtain text for the remote device, receive second text at the remote device using the text-input component, and utilize the second text at the remote device, such as discussed above in the context of at least FIGS. 3A-3C.

### V. Conclusion

Example methods and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. In the above detailed description, reference is made to the accompanying figures, which form a part thereof. In the figures, similar symbols typically identify similar components, unless context dictates otherwise.

The above detailed description describes various features and functions of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the ladder diagrams, scenarios, and flow charts in the figures and as discussed herein, each block and/or communication can represent a processing of information and/or a transmission of information in accordance with example embodiments. Alternative embodiments are included within the scope of these example embodiments. In these alternative embodiments, for example, functions described as blocks, transmissions, communications, requests, responses, and/or messages can be executed out of order from that shown or discussed, including substantially concurrent or in reverse order, depending on the functionality involved. Further, more or fewer blocks and/or functions can be used with any of the ladder diagrams, scenarios, and flow charts discussed herein, and these ladder diagrams, scenarios, and flow charts can be combined with one another, in part or in whole.

A block that represents a processing of information can correspond to circuitry that can be configured to perform the specific logical functions of a herein-described method or technique. Alternatively or additionally, a block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk or hard drive or other storage medium.

The computer readable medium can also include non-transitory computer readable media such as computer-readable media that stores data for short periods of time like register memory, processor cache, and random access memory (RAM). The computer readable media can also include non-transitory computer readable media that stores program code and/or data for longer periods of time, such as secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

Moreover, a block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

These as well as other aspects, advantages, and alternatives will become apparent to those of ordinary skill in the art by reading the following detailed description, with reference where appropriate to the accompanying drawings. Further, it should be understood that this description and figures provided herein are intended to illustrative embodiments by way of example only and, as such, that numerous variations are possible. For instance, structural elements and process steps can be rearranged, combined, distributed, eliminated, or otherwise changed, while remaining within the scope of the embodiments as claimed. The various aspects and embodiments disclosed herein are for purposes of illustration and are not intended to be limiting, with the true scope and spirit being indicated by the following claims.

We claim:

1. A method, comprising:
receiving, at a remote device, a notification of an event related to a head-mountable display (HMD);
determining, at the remote device, whether the event corresponds to a text input for the HMD; and
after determining that the event does correspond to the text input, the remote device:
causing display of a text-input interface on the HMD,
receiving text using a text-input component of the remote device, and
sending the text to the HMD.

2. The method of claim 1, wherein causing the display of the text-input interface on the HMD comprises causing a display of the text-input interface on the remote device.

3. The method of claim 1, further comprising:
determining that a network is accessible by the remote device;
determining, on the remote device, whether the network being accessible corresponds to text input for the HMD; and
after determining that the network being accessible corresponds to the text input for the HMD, determining that text is to be provided to the HMD.

4. The method of claim 1, wherein the remote device is a computing device selected from the group consisting of a smart phone, a desktop computing device, and a laptop computing device.

5. The method of claim 1, wherein sending the text to the HMD comprises:
sending a send text message comprising the text to the HMD, wherein the send text message is configured to identify a source application of the text.

6. The method of claim 5, further comprising:
receiving the send text message at the HMD;
determining, on the HMD, a counterpart application of the HMD to the source application; and
providing the text to the counterpart application of the HMD.

7. The method of claim 6, wherein providing the text to the counterpart application of the HMD comprises:
determining whether the counterpart application is active on the HMD;
after determining that the counterpart application is not executing on the HMD, responsively activating the counterpart application; and
after activating the counterpart application, providing the text to the counterpart application.

8. The method of claim 1, wherein the text-input component of the remote device comprises a physical keyboard.

9. The method of claim 1, wherein the text-input component comprises a text-input application configured for entering at least the text at the remote device.

10. The method of claim 1, wherein receiving text comprises:
in response to receiving the text, displaying the received text on the remote device.

11. The method of claim 1, wherein receiving the text comprises:
in response to receiving the text, displaying the received text as plain text on the HMD; and
in response to receiving the text, providing a display without the received text on the remote device.

12. The method of claim 1, wherein the text comprises one or more characters, and wherein the method further comprises:
determining a set of valid input characters; and
determining whether each character of the text is in the set of valid input characters.

13. A method, comprising:
receiving, at a remote device, an instruction for providing text to a head-mountable display (HMD), wherein the remote device is configured to communicate with the HMD;
responsive to the instruction, providing a text-input component of the remote device, wherein the text-input component is configured to obtain text for the HMD; and
after providing the text-input component, the remote device:
receiving first text using the text-input component, and
sending the first text to the HMD.

14. The method of claim 13, further comprising:
after sending the first text to the HMD, the remote device:
configuring the text-input component to obtain text for the remote device,
receiving second text at the remote device using the text-input component, and
utilizing the second text at the remote device.

15. The method of claim 13, wherein the remote device is a computing device selected from the group consisting of a smart phone, a desktop computing device, and a laptop computing device.

16. The method of claim 13, wherein sending the first text to the HMD comprises:
sending the first text to the HMD using a send text message, wherein the send text message is configured to identify a particular application as a source application of the first text.

17. The method of claim 16, further comprising:
receiving the send text message at the HMD;
determining, on the HMD, that the source application of the first text is the particular application;
determining a counterpart application of the HMD to the source application; and
providing the first text to the counterpart application of the HMD.

18. The method of claim 17, wherein providing the first text to the counterpart application of the HMD comprises:
determining whether the counterpart application is executing on the HMD;
after determining that the counterpart application is not executing on the HMD, responsively executing the counterpart application on the HMD; and
after executing the counterpart application on the HMD, providing the first text to the executing counterpart application.

19. A remote device, comprising:
a text-input component;
a processor; and
a non-transitory computer-readable medium configured to store program instructions that, when executed by the processor, cause the remote device to carry out functions comprising:
receiving a notification of an event related to a head-mountable display (HMD);
determining whether the event corresponds to a text input for the HMD; and
after determining that the event does correspond to the text input:
causing display of a text-input interface on the HMD,
receiving text using the text-input component, and
sending the text to the HMD.

20. The remote device of claim 19, wherein receiving the text comprises:
in response to receiving the text, displaying the received text as plain text on the HMD; and
in response to receiving the text, providing a display not including the received text on the remote device.
